(19) United States
(12) Patent Application Publication
(10) Pub. No.: US 2023/0040469 A1
(43) Pub. Date: Feb. 9, 2023

(54) ASSEMBLY FOR FORMING A THERMALLY INSULATED WALL, CONNECTING DEVICE, FASTENING DEVICE, AND PANEL

(71) Applicant: Laszlo MATHE, Budapest (HU)

(72) Inventor: Laszlo MATHE, Budapest (HU)

(21) Appl. No.: 17/782,351

(22) PCT Filed: Dec. 6, 2019
(86) PCT No.: PCT/EP2019/083951

§ 371 Date: Jun. 3, 2022

(51) Int. Cl. E04B 1/41; E04B 2/86; E04B 1/48

(52) U.S. Cl. CPC E04B 1/41; E04B 2/8652; E04B 1/48

(57) ABSTRACT

An arrangement for forming a thermally insulated wall is provided that includes two panels connected to one another by multiple connecting means, wherein each connecting means has two receiving openings. Each panel is provided with an insertion opening, and a fixing means is inserted into the receiving opening of the connecting means through the insertion opening. Each of the connecting means includes a holding means of a first kind configured to hold a horizontal reinforcing means that connects the connecting means to one another and a holding means of a second kind configured to hold a vertical reinforcing means that connects the connecting means to one another. Other aspects are described and claimed.

### CROSS-REFERENCE TO RELATED APPLICATION(S)

This application is the National Stage of International Patent Application No. PCT/EP2019/083951 filed on Dec. 6, 2019, which is herein incorporated by reference in its entirety.

### BACKGROUND

The invention relates to an arrangement for forming a thermally insulated wall, a connecting means, a fixing means and a panel.

Different thermally insulated walls are known from the state of the art. For example, thermally insulated walls are known which are composed of individual bricks. A disadvantage of such walls is, however, that their insulating effect is low and buildings composed of such walls consume a lot of energy.

In addition, walls are known which are made of concrete. In order to make them thermally insulating, such walls are usually provided with insulating materials later on. However, retrospective insulating measures of this kind are cumbersome and costly. Moreover, such insulating measures may lead to damages caused by moisture, for example.

### SUMMARY

It is therefore an object of the invention to overcome the disadvantages of the state of the art. In particular, the object of the invention is to create a thermally insulated wall which is easy, time-efficient and cost-efficient to produce. Another object of the invention is to provide a connecting means, a fixing means and a panel which allow the thermally insulated wall to be constructed time-efficiently and easily. Hence, the invention is based on the object of creating buildings with thermally insulated walls which consume less energy than brick buildings.

The object according to the invention is solved in particular by means of the features as described herein.

The invention relates in particular to an arrangement for forming a thermally insulated wall comprising at least two panels, wherein the panels are connected or connectable to one another by multiple connecting means, wherein the connecting means each have at least two receiving openings, wherein at least one insertion opening is provided in each of the panels, and wherein at least one, in particular rod-shaped, fixing means is inserted or can be inserted into the receiving opening of the connecting means through the at least one insertion opening.

It is preferably provided that the connecting means each comprise at least one holding means of a first kind and at least one holding means of a second kind, that the at least one holding means of the first kind is configured to hold a substantially horizontal reinforcing means, the substantially horizontal reinforcing means connecting at least two connecting means to one another, and that the at least one holding means of the second kind is configured to hold a substantially vertical reinforcing means, the substantially vertical reinforcing means connecting at least two connecting means to one another.

The panels preferably act as shuttering panels for forming a concrete wall. In contrast to conventional shuttering arrangements, such as conventional shuttering structures or hollow walls, the shuttering panels in the present arrangement are preferably made of a thermally insulating material. If concrete is poured between the panels for forming the wall, the panels cannot act as lost formwork in the conventional sense, but rather act as thermally insulating layers. To this end, the panels are preferably made of a dimensionally stable and thermally insulating material, in particular of heat-insulating material, of porous or foamed plastic, such as polystyrene.

The arrangement for forming a thermally insulated wall may comprise two panels which are arranged at a distance from one another, the panels being connected to one another, in particular releasably, by multiple connecting means. In particular, the panels comprise thermally insulating materials or are made up of thermally insulating materials.

Each connecting means may have at least two receiving openings, each receiving opening being configured to receive the fixing means. In other words: the receiving opening may be designed in such a way that the receiving opening is connected or connectable to the fixing means in a friction-locking and/or form-locking manner.

At least one insertion opening may be provided in each panel, the insertion opening being configured to receive the fixing means. In other words: the insertion opening may be designed in such a way that the insertion opening is connected or connectable to the fixing means in a friction-locking and/or form-locking manner.

It is in particular provided that the distance between the insertion opening and an outer surface of the respective panel, in particular an outer surface of the outer wall, is in the range of 15 mm up to and including 50 mm, in particular 20 mm up to and including 30 mm, and is in particular 20 mm or 30 mm. This distance may allow to prevent thermal bridges.

It is in particular provided that the distance between the insertion opening and an outer surface of the respective panel, in particular an outer surface of the inner wall, is in the range of 0.5 mm up to and including 20 mm, in particular 1 mm up to and including 10 mm, and is in particular 1 mm or 5 mm.

The fixing means is preferably rod-, bar- or tube-shaped. The fixing means can thus have an elongated shape. In particular, the fixing means has a round, angular and/or ellipsoidal cross-section and/or the shape of a letter, in particular the shape of a D.

Furthermore, the fixing means may be configured for the insertion into the at least one insertion opening and/or for the insertion into the at least one receiving opening. In other words: the fixing means may be designed for friction-locking and/or form-locking connection with the at least one insertion opening and/or for the friction-locking and/or form-locking connection with the at least one receiving opening.

The connecting means may comprise at least one, in particular two, three, four, five, six, seven, eight, nine or ten, holding means of the first kind.

The connecting means may comprise at least one, in particular two, three, four, five, six, seven, eight, nine or ten, holding means of the second kind.

The at least one holding means of the first kind may be designed to receive, attach, hold and/or fix a substantially horizontal reinforcing means.

The substantially horizontal reinforcing means may be attached and/or fixed to at least two connecting means. The substantially horizontal reinforcing means may be received and/or held by at least two connecting means.

The at least one holding means of the second kind may be designed to receive, attach, hold and/or fix a substantially vertical reinforcing means.

The substantially vertical reinforcing means may be attached and/or fixed to at least two connecting means. The substantially vertical reinforcing means may be received and/or held by at least two connecting means.

The reinforcing means may be designed as armours or reinforcements. It may in particular be provided that the at least one holding means of the first kind and/or the at least one holding means of the second kind is/are configured for holding, fastening, fixing and/or receiving reinforcing mats.

In the context of the present invention the substantially horizontal reinforcing means can be understood as a reinforcing means which is located substantially horizontally to the ground. However, “substantially horizontal” may also be understood to include a range which deviates from horizontal by +25° up to and including −25°, in particular +10° up to and including −10°.

In the context of the present invention the substantially vertical reinforcing means can be understood as a reinforcing means which is located substantially perpendicularly to the ground. However, “substantially vertical” may also be understood to include a range which deviates from vertical by +25° up to and including −25°, in particular +10° up to and including −10°.

In particular, at least two substantially horizontal reinforcing means and/or at least two substantially vertical reinforcing means may be arranged in a plane, this plane being parallel to a lateral surface of the panel.

The arrangement is in particular made up of multiple parts, i. e. two panels, multiple connecting means and multiple fixing means. Optionally, the connecting means may be connected to one another, in particular releasably, by multiple reinforcing means.

It is optionally provided that the thermally insulated wall and a building comprising these walls are built by the subsequent process steps. In a first step, a foundation may be built. The panels connected by the connecting means may be attached to the foundation, in particular to previously inserted reinforcements. Then, the reinforcing means may be inserted into the holding means of the connecting means. Optionally, ceiling modules, and in particular reinforcing mats, may be arranged between the panels. Then, concrete may be poured between the panels and the ceiling modules.

The thermally insulating wall is preferably made up of two panels and the concrete which has been poured between the two panels.

The above described method allows the easy, cost-efficient and time-efficient formation of a thermally insulated wall with a good thermal insulation.

It is optionally provided that the connecting means are arranged at a distance from one another and/or that the connecting means connected by the substantially horizontal reinforcing means are arranged in a plane, in particular a horizontal plane, and/or that the connecting means connected by the substantially vertical reinforcing means are arranged in a plane, in particular a vertical plane.

In the horizontal direction, the connecting means, the insertion openings and/or the connecting openings may be arranged at a distance in the range of 5 cm up to and including 100 cm, in particular 20 cm up to and including 80 cm, from one another.

In the vertical direction, the connecting means, the insertion openings and/or the connecting openings may be arranged at a distance in the range of 5 cm up to and including 100 cm, in particular 20 cm up to and including 80 cm, from one another.

In the horizontal as well as the vertical direction, the connecting means, the insertion openings and/or the connecting openings are preferably arranged at a distance of 20 cm from one another.

The connecting means connected by the substantially horizontal reinforcing means may be arranged substantially aligned.

The connecting means connected by the substantially vertical reinforcing means may be arranged substantially aligned.

It is optionally provided that the at least one holding means of the first kind and/or the at least one holding means of the second kind is/are designed as opening, cut-out and/or recess and/or that the at least one holding means of the first kind and/or the at least one holding means of the second kind are provided on or in the connecting means.

The at least one holding means of the first kind and/or the at least one holding means of the second kind may be designed differently or identically.

It is in particular provided that the at least one holding means of the first kind and/or the at least one holding means of the second kind have different sizes and/or shapes.

The at least one holding means of the first kind and/or the at least one holding means of the second kind may be designed for holding, fastening, fixing and/or receiving differently designed reinforcing means.

It is in particular provided that the at least one holding means of the first kind and/or the at least one holding means of the second kind have different sizes and/or different shapes.

It is optionally provided that the at least one holding means of the first kind and the at least one holding means of the second kind form an angle in the range of 60° to 120°, in particular an angle of 90°.

It is optionally provided that the connecting means is designed in such a way that by inserting the substantially horizontal reinforcing means into the holding means of the first kind the holding means of the second kind is formed or that the connecting means is designed in such a way that by inserting the substantially vertical reinforcing means into the holding means of the second kind the holding means of the first kind is formed.

In other words: the connecting means may be designed in such a way that by inserting a reinforcing means into the holding means of one kind the holding means of the other kind is formed.

The holding means of one kind is preferably folded out of the connecting means by inserting the reinforcing means into the holding means of the other kind.

It may in particular be provided that the holding means of one kind is formed by the connecting means and/or that the holding means of one kind is arranged in the connecting means.

It may in particular be provided that the holding means of the other kind is arranged on the connecting means and/or that the holding means of the other kind is formed by a part arranged on the connecting means and connected to the connecting means.

It is optionally provided that the at least one holding means of the first kind and/or the at least one holding means of the second kind can be brought, in particular folded, from a first state into a second state, that the at least one holding means of the first kind and/or the at least one holding means of the second kind is/are folded in in the first state so that the at least one holding means of the first kind and/or the at least one holding means of the second kind is/are arranged inside the connecting means, in particular within the dimensions of the connecting means, and that the at least one holding means of the first kind and/or the at least one holding means of the second kind is/are folded out in the second state so that the at least one holding means of the first kind and/or the at least one holding means of the second kind project/s beyond the connecting means, in particular at at least one side of the connecting means.

The holding means may be arranged on a connecting means.

In the first state, the at least one holding means of the first kind and/or the at least one holding means of the second kind may in particular be folded in.

In the first state, the at least one holding means of the first kind and/or the at least one holding means of the second kind may be arranged in the connecting means, in particular without projecting beyond it.

In the first state, the at least one holding means of the first kind and/or the at least one holding means of the second kind is/are preferably arranged within the dimensions of the connecting means.

In other words: the at least one holding means of the first kind and/or the at least one holding means of the second kind cannot project beyond the connecting means in the first state. This allows the connecting means to be transported time-efficiently and easily in the first state.

In the second state, the at least one holding means of the first kind and/or the at least one holding means of the second kind can be in a folded-out state.

In the second state, the at least one holding means of the first kind and/or the at least one holding means of the second kind may project beyond the connecting means.

In the second state, the at least one holding means of the first kind and/or the at least one holding means of the second kind preferably extend/s away from at least one side of the connecting means.

It may in particular be provided that the at least one holding means of one kind can be folded out of the connecting means and that the at least one holding means of the other kind is formed by the connecting means.

The insertion openings may be punched out of the connecting means. The holding means of at least one kind may be made by casting.

It is optionally provided that the substantially horizontal reinforcing means is designed in such a way that this reinforcing means can be inserted into the holding means of the first kind when the panels are connected to one another by the connecting means, and/or that the substantially vertical reinforcing means is designed in such a way that this reinforcing means can be inserted into the holding means of the second kind when the panels are connected to one another by the connecting means.

It may be provided in all embodiments that all substantially horizontal or vertical reinforcing means are designed identically or in the manner described above.

The connecting means may be connected to one another by the reinforcing means when the panels are connected to one another by the connecting means.

The holding means may be designed in such a way that the connecting means can be inserted into the holding means when the panels are connected to one another by the connecting means.

The connecting means and/or the holding means are optionally designed in such a way that the reinforcing means can be inserted into the holding means when the panels are connected to one another by the connecting means.

It is optionally provided that the connecting means has the shape of an L at least in some sections, and/or that the at least one holding means of the first kind is arranged on a lateral surface of the connecting means which in particular extends in a vertical direction, and/or that the at least one holding means of the second kind is arranged on the other lateral surface of the connecting means which in particular extends in a horizontal direction.

The connecting means may optionally have the shape of an L and/or U, at least in some sections.

The connecting means may be designed in such a way that the connecting means closes the connecting opening in the panels. This can prevent the concrete from penetrating into the panels.

The at least one holding means of the first kind may be arranged in a lateral surface of the connecting means and the at least one holding means of the second kind may be arranged in another lateral surface of the connecting means.

It is optionally provided that the at least one holding means of the first kind and/or the at least one holding means of the second kind is/are arranged substantially symmetrically around the centre of the connecting means, and/or that the at least one holding means of the first kind and/or the at least one holding means of the second kind is/are arranged at a distance of 2 cm up to and including 35 cm, in particular 10 cm up to and including 25 cm, from the at least one insertion opening, and/or that the at least one holding means of the first kind and/or the at least one holding means of the second kind is/are arranged at a distance of 5 cm up to and including 40 cm, in particular 10 cm up to and including 25 cm, from the respective end region of the connecting means.

The at least one holding means of the first kind and/or the at least one holding means of the second kind is/are optionally arranged at a distance of 5 cm up to and including 40 cm, in particular 10 cm up to and including 25 cm, from the at least one insertion region.

The holding means of one kind are in particular arranged at a distance of 2 cm up to and including 35 cm, in particular 5 cm up to and including 25 cm, from one another.

It is optionally provided that the reinforcing means has the shape of a rod, bar or tube, and/or that the reinforcing means comprises metal, optical fibre and/or carbon fibre, and/or that the reinforcing means is made of metal, optical fibre and/or carbon fibre, and/or that the reinforcing means is configured to absorb tensile forces.

The reinforcing means is preferably designed as substantially straight rod, bar or tube.

The reinforcing means may in particular be made of steel or comprise steel.

The reinforcing means may be configured to reinforce the arrangement.

The at least one substantially horizontal reinforcing means optionally has a length of 200 cm up to and including 500 cm, in particular a length of 300 cm up to and including 400 cm, preferably a length corresponding to the height of the respective panel.

The at least one substantially vertical reinforcing means optionally has a length of 50 cm up to and including 400 cm, in particular a length of 100 cm up to and including 200 cm, preferably a length corresponding to the width of the respective panel.

The reinforcing means preferably have a diameter in the range of 1 mm up to and including 80 mm, in particular in the range of 6 mm up to and including 50 mm.

The reinforcing means may optionally have an insertion section, wherein the insertion section may be configured for the insertion into the holding means.

It is optionally provided that the at least one fixing means has a substantially flat surface along its longitudinal direction.

It is in particular provided that the fixing means has a substantially flat surface along its longitudinal extension. That means optionally that a substantially flat surface may be provided on the circumference of the jacket surface of the fixing means. The substantially flat surface preferably extends over the entire length of the fixing means. In the context of the invention a substantially flat surface may be understood to mean a flat and/or smooth surface. An outer surface of the fixing means may in particular be substantially flat.

The fixing means, in particular the cross-section of the fixing means, may for example be triangular, quadrangular, pentagonal, hexagonal, heptagonal, octagonal, ninogonal, decagonal, polygonal, quadrantal, semicircular or partially circular. The fixing means, in particular the cross-section of the fixing means, may optionally have the shape of a letter and may preferably be D-shaped.

Given that one side of the fixing means has a substantially flat surface, the penetration and/or cutting of the fixing means into the panel can be reduced. Furthermore, this allows a rotation of the fixing means in the insertion opening and in particular during the insertion of the fixing means into the insertion opening to be reduced and/or prevented.

The invention relates in particular to an arrangement for forming a thermally insulated wall comprising at least two panels, wherein the panels are connected or connectable to one another by multiple connecting means, wherein the connecting means each have at least two receiving openings, wherein at least one insertion opening is provided in each of the panels, wherein at least one, in particular rod-shaped, fixing means is inserted or can be inserted into the receiving opening of the connecting means through the at least one insertion opening, and wherein the at least one fixing means has at least one substantially flat surface along its longitudinal direction.

It is optionally provided that the or a substantially flat surface of the fixing means points in the direction of the other panel, and/or that the or a substantially flat surface of the fixing means is substantially parallel to an outer surface of the panel.

The fixing means is in particular arranged in the insertion opening of the panel in such a way that a cutting and/or penetration of the fixing means can be prevented and/or reduced when the panels are pushed or moved away from one another.

In case the two panels which are connected by the connecting means are pushed away from one another, the fixing means arranged in the insertion opening may be pressed against the so-called compression side of the insertion opening. The substantially flat surface preferably points in the direction of the compression side or abuts the compression side.

The flat surface of the fixing means is preferably substantially normal to the pressure force when the panels are pushed or moved away from one another. The panels are in particular pushed or moved away from one another when concrete is poured between the panels.

It is optionally provided that the at least one fixing means is at least partially arranged in the at least one insertion opening of the panel, and/or that connecting openings are provided in the panel, wherein the connecting means are at least partially arranged in the connecting openings, and/or that the connecting means are arranged substantially orthogonally to the at least one fixing means.

It is preferably provided that the fixing means is arranged substantially completely in the insertion opening of the panel so that the fixing means is inserted into the receiving opening of the associated connecting means.

It is in particular provided that each connecting means has two insertion sections. These insertion sections are preferably configured to be inserted into the panels and in particular into connecting openings of the panels.

The connecting openings may be connected to the associated insertion openings. Hence, also the insertion opening may be connected to the associated connecting openings.

It may be provided that the connecting means are at least partially arranged in the panels. A part of the connecting means that is inserted into the respective panel is in particular in the range of 5 cm up to and including 35 cm, in particular in the range of 7 cm up to and including 25 cm.

Preferably, a first insertion section is arranged in the connecting opening of a panel and a second insertion section is arranged in the connecting opening of the panel opposite this panel. The two insertion sections are in particular opposite one another and provided at a distance from one another on the connecting means.

The insertion opening and the associated connecting openings are preferably arranged substantially orthogonally to one another.

In particular, the insertion opening and the associated connecting openings form an angle in the range of 45° up to and including 105°, in particular in the range of 85° up to and including 95°, and preferably 90°.

In particular, the fixing means and the associated connecting means form an angle in the range of 45° up to and including 105°, in particular in the range of 85° up to and including 95°, and preferably 90°.

It is optionally provided that the at least one fixing means is inserted or can be inserted into multiple receiving openings, which are in particular in alignment with one another, through the at least one insertion opening of the panel.

The connecting means are preferably provided in such a way in the panel that the fixing means can be inserted into multiple receiving openings.

It is optionally provided that the receiving openings of the connecting means are configured to receive the at least one fixing means, and/or that the receiving openings substantially correspond to the shape, in particular of the cross-section, of the at least one fixing means.

It is optionally provided that the at least one insertion opening of the panels is configured to receive the at least one fixing means, and that the at least one insertion opening substantially corresponds to the shape of the at least one fixing means.

It is in particular provided that the receiving openings and/or the at least one insertion opening substantially have the shape of the at least one fixing means.

It is in particular provided that the cross-section of the receiving openings and/or the cross-section of the at least one insertion opening substantially correspond to the cross-section of the at least one fixing means.

It is optionally provided that the connecting means has at least one, in particular pivotable, positioning means, and/or that the positioning means is configured to position the connecting means and/or the fixing means, and/or that the positioning means can be brought from a insertion position, in which the positioning means unblocks substantially the entire receiving opening, into a positioning position, in which the positioning means positions the connecting means and/or the fixing means.

The positioning means is preferably designed as a flexible flap. The positioning means may in particular be able to be brought from its insertion position into its positioning position by spring force. The positioning means may optionally be configured to orient the connecting means and/or the fixing means.

The receiving opening is optionally bigger than the cross-section of the fixing means. The receiving opening may be reduced to substantially the cross-section of the fixing means when the positioning means is in its positioning position. In the positioning position the positioning means may abut the fixing means. In the insertion position of the positioning means the positioning means may unblock the receiving opening so that the fixing means can be inserted into the receiving opening more easily.

This allows the insertion and/or introduction of the fixing means into the receiving openings to be facilitated. In the positioning position, the positioning means may also limit the mobility of the fixing means.

The positioning means is in particular arranged on the connecting means in such a way that it abuts, substantially exclusively, the substantially flat surface of the fixing means. The positioning means may be provided on the compression side of the receiving opening.

In the context of the invention, the insertion position may be understood to mean a first position and the positioning position may be understood to mean a second position of the positioning means.

It is optionally provided that the connecting means has at least one spacer, wherein the at least one spacer is arranged on the circumference of the receiving opening, and/or wherein the at least on spacer is arranged on the circumference of the connecting means, and/or wherein the at least one spacer is/are in particular arranged on the circumference of the at least one holding means of the first kind and/or the at least one holding means of the second kind, and/or wherein the at least one spacer is/are arranged on the circumference of the substantially horizontal reinforcing means and/or the substantially vertical reinforcing means.

The circumference of the connecting means, the circumference of the receiving opening, the circumference of the holding means and/or the circumference of the reinforcing means may at least partially be provided with a toothing.

In particular, at least one spacer, in particular multiple spacers, is/are arranged on the circumference of the connecting means, the circumference of the receiving opening, the circumference of the holding means and/or the circumference of the reinforcing means.

The receiving opening may have an inner toothing. The region of the receiving opening on which the positioning means is provided is preferably designed without a spacer.

The spacer may be designed in such a way that the friction between the fixing means and the receiving opening is reduced, facilitating an insertion of the fixing means into the receiving opening.

The spacer may be designed in such a way that the friction between the connecting means and the panel is reduced, facilitating an insertion of the fixing means into the panel, in particular into the connecting openings of the panel.

The spacer may be designed in such a way that the friction between the holding means and the reinforcing means is reduced, facilitating an insertion of the reinforcing means into the holding means.

The panels are optionally made of plastic, in particular extruded polystyrene or expanded polystyrene.

The panels may comprise any thermally insulating material or be made of any thermally insulating material.

In particular, the panels have a density in the range of 10 kg/m³ to 40 kg/m³, preferably in the range of 20 kg/m³ to 30 kg/m³.

In particular, the panels have a heat transition coefficient in the range of 0.100 W/(m²·K) to 0.190 W/(m²·K), in particular in the range of 0.108 W/(m²·K) to 0.12 W/(m²·K).

The heat transition coefficient depends in particular on the lambda value of the raw material, wherein the lambda value is in the range of 0.02 up to and including 0.05, in particular 0.030 up to and including 0.036.

It is optionally provided that the panels have a height in the range of 250 cm up to and including 400 cm, in particular 300 cm up to and including 350 cm, and preferably a height of 320 cm, and/or that the panels have a width in the range of 50 cm up to and including 200 cm, in particular 100 cm up to and including 150 cm, and preferably a width of 120 cm, and/or that the panels have a depth in the range of 5 cm up to and including 80 cm, in particular 8 cm up to and including 30 cm, and preferably a depth of 14 cm or 16 cm.

It is optionally provided that the panels are arranged at a distance from one another and/or that the distance between the panels is in the range of 5 cm up to and including 50 cm, preferably in the range of 10 cm up to and including 40 cm, and is preferably 10 cm, 15 cm or 30 cm.

It is optionally provided that at least one expansion joint is provided on at least one outer surface of at least one panel, and/or that the at least one expansion joint extends across the entire width of the panel and/or has a length in the range of 50 cm up to and including 200 cm, in particular 100 cm up to and including 150 cm, and preferably a length of 120 cm, and/or that the at least one expansion joint has a height in the range of 0.1 up to and including 5 mm, in particular 1 mm, and/or that the at least one expansion joint has a depth in the range of 1 mm up to and including 20 mm, in particular 10 mm, and/or that two expansion joints are optionally provided on a panel and that the distance between these two expansion joints is in the range of 10 cm up to and including 120 cm, in particular in the range of 20 cm up to and including 100 cm, and is preferably 20 cm.

The expansion joints allow the panel to expand and compress.

It is optionally provided that the receiving openings are arranged opposite each other on the connecting means, and/or that the distance between the receiving openings is in particular in the range of 15 cm up to and including 70 cm, in particular 30 cm up to and including 60 cm.

It is optionally provided that the connecting means has two insertion sections, and/or that the insertion sections are configured for the insertion into the panels and in particular for the insertion into the connecting openings of the panels, and/or that the insertion sections are bevelled, rounded and/or pointed.

It is preferably provided that the two insertion sections are opposite each other. The insertion sections are in particular arranged entirely inside the panels.

It is optionally provided that the fixing means has at least one insertion region, that the at least one insertion region is configured for the insertion into the panels, in particular for the insertion into the insertion opening of the panels, and/or for the insertion into the receiving opening of the connecting means, and/or that the at least one insertion section is bevelled, rounded and/or pointed.

It is optionally provided that the connecting means have a length in the range of 25 cm up to and including 80 cm, in particular 30 cm up to and including 60 cm, and/or that the connecting means have a width in the range of 5 mm up to and including 100 mm, in particular 10 mm up to and including 40 mm, and/or that the connecting means have a depth in the range of 5 mm up to and including 100 mm, in particular 10 mm up to and including 40 mm.

It is in particular provided that the connecting means are adapted to the dimensions, in particular the diameter, of the reinforcing means.

The width and/or the depth of the connecting means is optionally bigger than the diameter of the respective reinforcing means.

It is optionally provided that the fixing means has a length in the range of 50 cm to 200 cm, in particular 100 cm up to and including 200 cm, and preferably a length of 120 cm, and/or that the fixing means has a width in the range of 5 mm up to and including 50 mm, in particular 15 mm up to and including 40 mm, and/or that the fixing means has a depth in the range of 5 mm up to and including 50 mm, in particular 15 mm up to and including 40 mm.

The length of the fixing means in particular corresponds to the width of the respective panel.

The fixing means preferably have a diameter in the range of 5 mm up to and including 50 mm, in particular 10 mm up to and including 40 mm.

In particular, the invention relates to a connecting means with at least two receiving openings for the reception of the inventive fixing means, wherein the connecting means comprises at least one inventive holding means of the first kind and at least one inventive holding means of the second kind and wherein the connecting means is configured to connect the panels of the inventive arrangement.

The invention optionally relates to an inventive connecting means, an inventive fixing means, an inventive reinforcing means and/or an inventive panel.

In particular, the invention relates to a fixing means configured for the insertion into the insertion opening of the panels and into the receiving opening of the connecting means of the inventive arrangement.

The fixing means is preferably configured to fix the connecting means in the panel.

In particular, the invention relates to a panel having at least one connecting opening for the insertion of the inventive connecting means, the panel having at least one insertion opening for the insertion of the inventive fixing means.

Further features according to the invention optionally emerge from the claims, the description of the exemplary embodiments and the figures.

The invention is now further explained on the basis of non-exclusive and/or non-limiting exemplary embodiments.

### BRIEF DESCRIPTION OF THE DRAWINGS

FIG. 1a shows a schematic, three-dimensional view of a first embodiment of the inventive arrangement for forming a thermally insulated wall,

FIG. 1b shows a panel of the first embodiment of the inventive arrangement,

FIG. 2 shows a schematic, three-dimensional view of a first embodiment of an inventive connecting means,

FIG. 3 shows a schematic, three-dimensional view of a second embodiment of the inventive arrangement for forming a thermally insulated wall,

FIG. 4a shows a schematic, three-dimensional view of a second embodiment of an inventive connecting means in its first state,

FIGS. 4b and 4c show schematic, three-dimensional views of the second embodiment of an inventive connecting means in its second state,

FIG. 5 shows a schematic, three-dimensional view of a third embodiment of the arrangement for forming a thermally insulated wall,

FIG. 6 shows a schematic view of a third embodiment of a connecting means,

FIG. 7a shows a schematic view of a fourth embodiment of a connecting means,

FIG. 7b shows a three-dimensional view of the fourth embodiment of a connecting means,

FIG. 8a shows a schematic view of a first embodiment of an inventive fixing means,

FIG. 8b shows a floor plan view of the first embodiment of an inventive fixing means,

FIG. 9a shows a schematic view of a second embodiment of an inventive fixing means,

FIG. 9b shows a floor plan view of the second embodiment of an inventive fixing means,

FIG. 10a shows a schematic, three-dimensional view of a third embodiment of an inventive fixing means, and

FIG. 10b shows a floor plan view of the third embodiment of an inventive fixing means.

### DETAILED DESCRIPTION OF THE PREFERRED EMBODIMENTS

Unless otherwise indicated, the reference numbers correspond to the following components: Panel 1, connecting means 2, receiving opening 3, insertion opening 4, fixing means 5, flat surface 6, connecting opening 7, angle 8, expansion joint 9, spacer 10, positioning means 11, insertion region 12, insertion section 13, horizontal reinforcing means 14, vertical reinforcing means 15, holding means of the first kind 16 and holding means of the second kind 17.

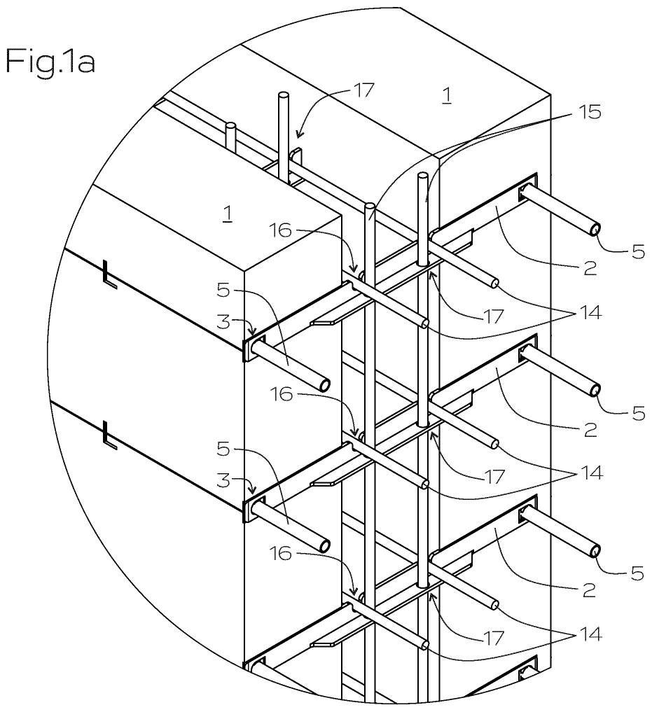

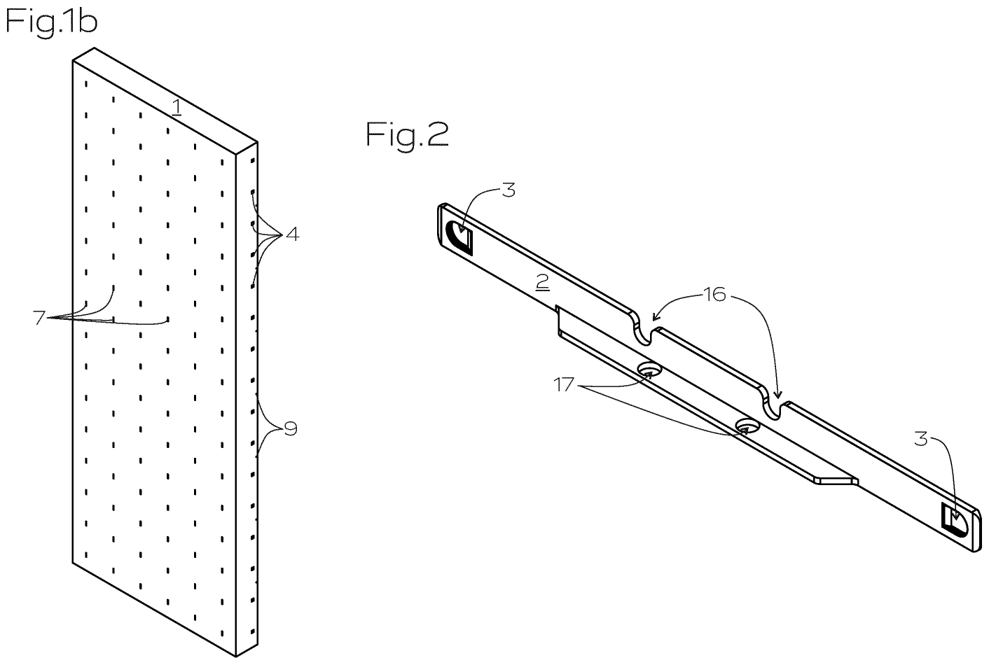

FIGS. 1a and 1b show schematic views of a first embodiment of the inventive arrangement for forming a thermally insulated wall. The connecting means 2 of this embodiment is shown in more detail in FIG. 2.

In this embodiment, two panels 1 which are arranged at a distance from one another are connected by multiple connecting means 2 which are arranged at a distance from one another.

The panels 1 are made of polystyrene and have a height in the range of 320 cm up to and including 350 cm, a width in the range of 100 cm up to and including 120 cm and a depth in the range of 8 cm up to and including 25 cm. The distance between the panels 1 is in the range of 10 cm up to and including 30 cm.

The connecting means 2 are arranged in connecting openings 7 of the panels 1 and the fixing means 5 are arranged in insertion openings 4 of the panels 1. The insertion openings 4 are connected to their associated connecting openings 7.

According to this embodiment, the connecting openings 7 are substantially orthogonal to the associated insertion openings 4. The connecting means 2 arranged in the connecting openings 7 further form an angle 8 of substantially 90° with the fixing means 5, which engages the receiving openings 3 of these connecting means 2.

The connecting means 2 has two receiving openings 3. Each panel 1 has multiple insertion openings 4 configured for the insertion of fixing means 5. Via the insertion openings 4, the fixing means 5 are inserted into the panels 1 and simultaneously into the receiving openings 3 of the connecting means 2.

According to this embodiment, the respective connecting means 2 has two insertion sections 13 arranged at the ends of the connecting means 2. The insertion sections 13 are configured for the insertion into the connecting openings 7 of the panels 1 and are in particular rounded.

The connecting means 2 are inserted into the connecting openings 7 of the panels 1, insertion sections 13 first.

The connecting means 2 further have two holding means of the first kind 16 and two holding means of the second kind 17 each. The holding means 16, 17 are configured to hold the reinforcing means 14, 15.

The connecting means 2 are connected to one another by reinforcing means 14, 15.

At least in some sections, the connecting means 2 are L-shaped. Two holding means of the first kind 16 are arranged on the lateral surface of the connecting means 2 which extends in the vertical direction. Two holding means of the second kind 17 are arranged on the lateral surface of the connecting means 2 which extends in the horizontal direction. The holding means 16, 17 are further arranged symmetrically around the center of the connecting means 2.

According to this embodiment, the reinforcing means 14, 15 are designed in such a way that the reinforcing means 14, 15 can be inserted into the holding means 16, 17 when the panels 1 are connected to one another by the connecting means 2.

The reinforcing means 14, 15 are rod-shaped and made of metal.

According to this embodiment, the holding means of the first kind 16 are designed as recesses and the holding means of the second kind 17 are designed as an opening. The holding means 16, 17 are further provided on and in the connecting means 2, respectively.

The holding means of the first kind 16 are configured to hold the substantially horizontal reinforcing means 14. The connecting means 2 connected by the substantially horizontal reinforcing means 14 are arranged in a horizontal plane.

The holding means of the second kind 17 are configured to hold the substantially vertical reinforcing means 15. The connecting means 2 connected by the substantially vertical reinforcing means 15 are arranged in a vertical plane.

According to this embodiment, the fixing means 5 are rod-shaped.

The receiving openings 3 of the connecting means 2 and the insertion openings 4 of the panels 1 are configured to receive the fixing means 5 and substantially correspond to the shape, in particular of the cross-section, of the fixing means 5.

The receiving openings 3 associated to a fixing means 5 are arranged in alignment. By inserting it into the insertion opening 4 the fixing means 5 can thus be inserted into multiple receiving openings 3.

Expansion joints 9 which extend across the entire width of the panel 1 and have a width of 1 mm and a depth of 10 mm are provided on the outer surface of the panels 1. The distance between two expansion joints 9 is 20 cm.

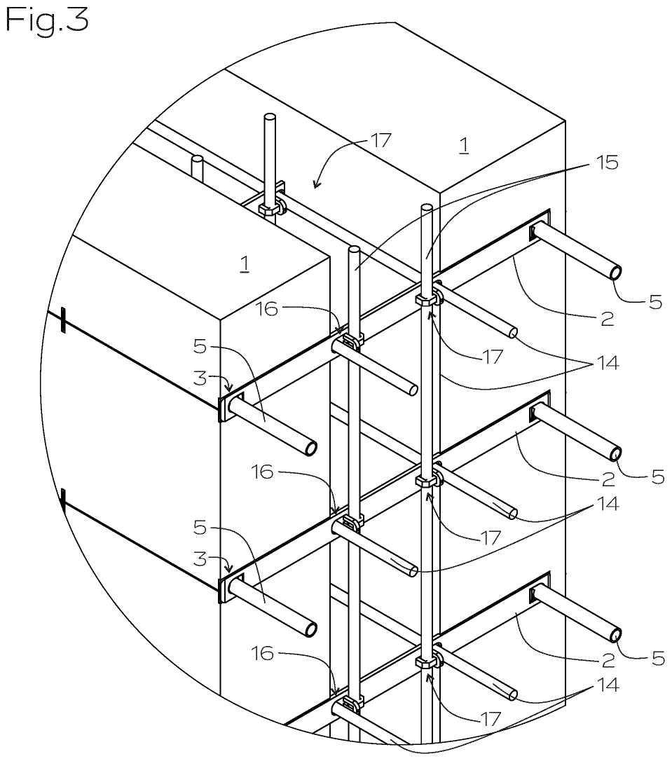

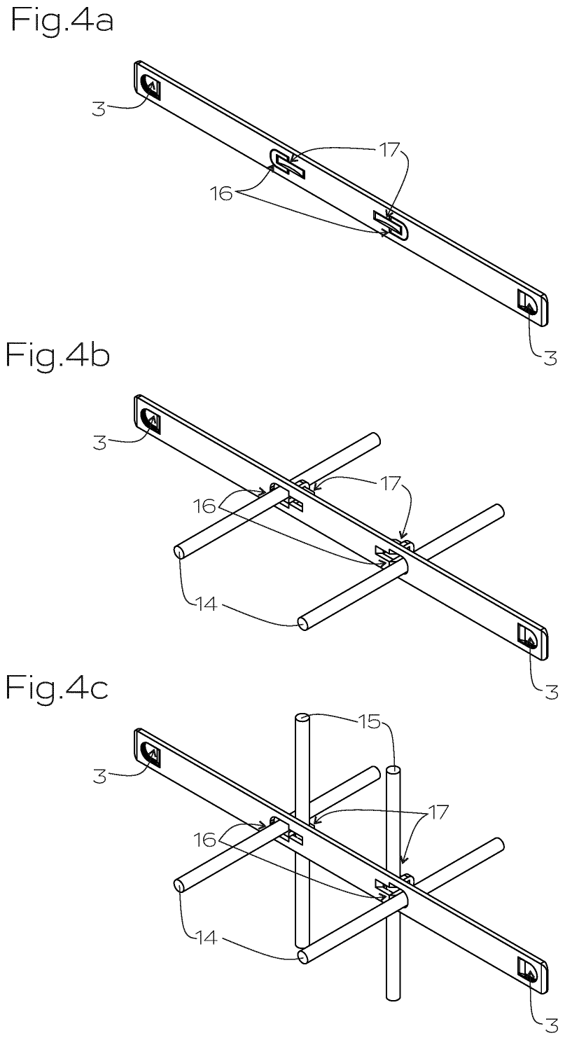

FIG. 3 shows a schematic view of a second embodiment of the inventive arrangement for forming a thermally insulated wall. The connecting means 2 of this embodiment is shown in more detail in FIGS. 4a, 4b and 4c. The features of the embodiment according to FIGS. 3, 4a, 4b and 4c may preferably correspond to the features of the embodiment according to FIGS. 1a, 1b and/or 2.

According to this embodiment the connecting means 2 are designed in such a way that by inserting the substantially horizontal reinforcing means 14 into the holding means of the first kind 16 the holding means of the second kind 17 is formed.

As shown in FIG. 4b, the holding means 16, 17 are folded from a first state into a second state.

The first state, i.e. the folded-in state, of the holding means 16, 17 is shown in FIG. 4a. In the first state, the holding means 16, 17 are arranged within the connecting means 2, in particular within the dimensions of the connecting means 2.

In case the substantially horizontal reinforcing means 14 are inserted into the holding means of the first kind 16, the holding means of the second kind 17 are folded out. The holding means of the second kind 17 project beyond the connecting means 2 on at least one side of the connecting means 2.

In the second state of the holding means of the second kind 17 the substantially vertical reinforcing means 15 may be inserted.

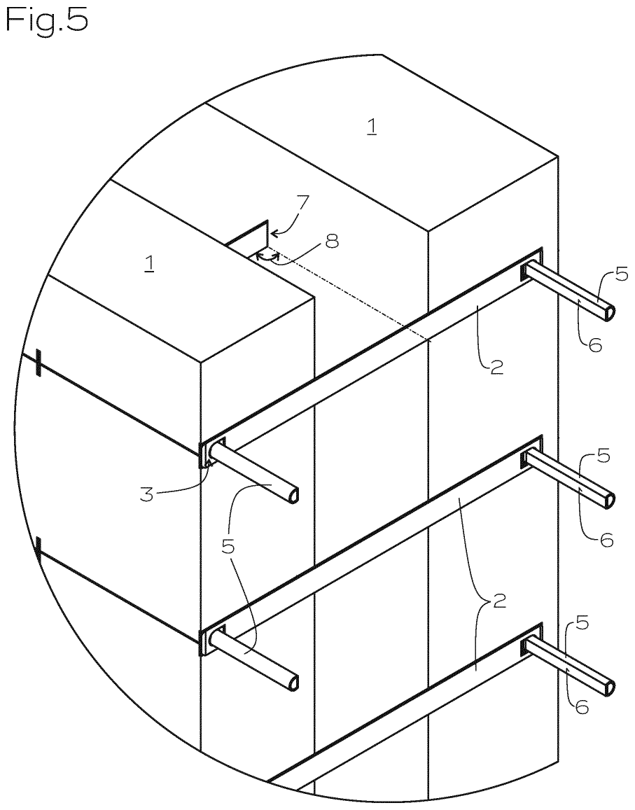

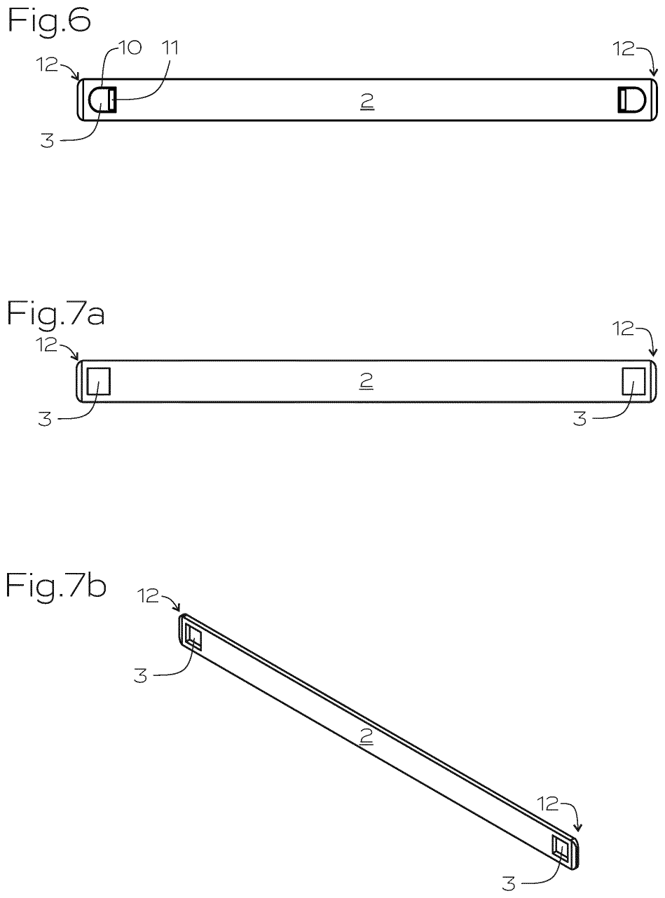

FIG. 5 shows a schematic view of a third embodiment of an arrangement for forming a thermally insulated wall. The connecting means 2 of this embodiment is shown in more detail in FIG. 6. The features of the embodiment according to FIGS. 5 and 6 may preferably correspond to the features of the embodiments according to FIGS. 1a, 1b, 2, 3, 4a, 4b and/or 4c.

According to this embodiment no holding means 16, 17 are arranged on the connecting means 2.

The connecting means 2 has a length in the range of 25 cm up to and including 80 cm, a width of 5 mm and a height of 50 mm. The receiving openings 3 are arranged opposite each other. The distance between the receiving openings 3 is in the range of 30 cm up to and including 70 cm.

Multiple spacers 10 are arranged on the circumference of the receiving openings 3. In other words: the receiving opening 3 has a toothing. The region of the receiving opening 3 in which the positioning means 11 is arranged is designed without a spacer or toothing.

According to a further embodiment the circumference of the connecting means 2 may also be provided with spacers 10, at least in some sections.

A pivotable positioning means 11 is further arranged in the receiving opening 3, wherein the positioning means 11 has two positions. In an insertion position, the positioning means 11 is pivoted relative to the connecting means 2 and substantially unblocks the receiving opening 3. Given that the cross-section of the receiving opening 3 is bigger than the cross-section of the fixing means 5, the fixing means 5 may be easily inserted into the receiving opening 3.

In the positioning position of the positioning means 11 the positioning means 11 presses on the fixing means 6 by spring force. This allows the connecting means 2 to be positioned opposite the fixing means 5. It further allows the fixing means 5 to be fixed in the receiving opening 3.

FIGS. 7a and 7b show schematic views of a fourth embodiment of a connecting means 2. The features of the embodiment according to FIGS. 7a and 7b may preferably correspond to the features of the embodiments according to FIGS. 1a, 1b, 2, 3, 4a, 4b, 4c, 5 and/or 6.

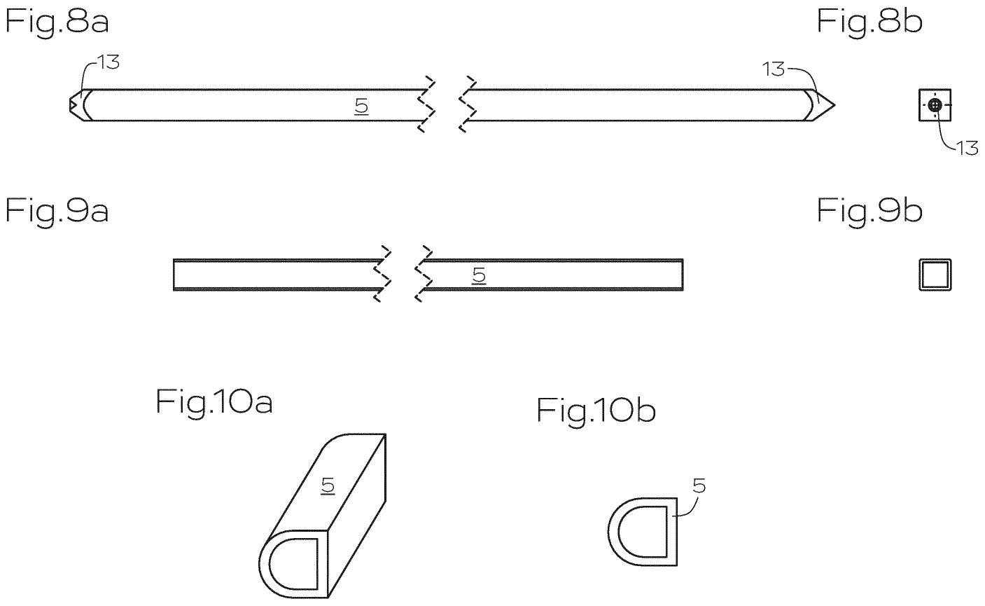

FIGS. 8a and 8b show a schematic view of a first embodiment of an inventive fixing means 5. The features of the embodiment according to FIGS. 8a and 8b may preferably correspond to the features of the embodiments according to FIGS. 1a, 1b, 2, 3, 4a, 4b, 4c, 5, 6, 7a and/or 7b.

The fixing means 5 has a length in the range of 320 cm up to and including 350 cm and a diameter of 20 mm.

The fixing means 5 according to this embodiment further has two insertion regions 12 opposite each other. The insertion regions 12 are configured for the insertion into the panels 1, in particular for the insertion into the insertion opening 4 of the panel 1, and/or into the receiving opening 3 of the connecting means 2. Further, one insertion region 12 is rounded and the other insertion region 12 is pointed.

FIGS. 9a, 9b, 10a and 10b show a schematic view of a first and second embodiment of an inventive fixing means 5. The features of the embodiment according to FIGS. 9a, 9b, 10a and 10b may preferably correspond to the features of the embodiments according to FIGS. 1a, 1b, 2, 3, 4a, 4b, 4c, 5, 6, 7a, 7b, 8a and/or 8b.

The fixing means 5 further have a substantially flat surface 6 along their longitudinal direction. The cross-section of the fixing means 5 is D-shaped. The fixing means 5 according to this embodiment is shown in FIGS. 10a and 10b.

According to this embodiment, the fixing means 5 is arranged in the insertion opening 4 in such a way that the substantially flat surface 6 of the fixing means 5 points in the direction of the other panel 1. The substantially flat surface 6 of the fixing means 5 is further substantially parallel to the outer surface of the panel 1.

These configurations may be provided in all embodiments.

This exemplary configuration allows the inventive effects to be achieved.

The range of protection of the invention is not limited to this exemplary embodiment, but comprises any arrangement, any connecting means 2, any fixing means 5 and any panel 1 within the scope of the following patent claims.

1. An arrangement for forming a thermally insulating wall, comprising:
at least two panels connected or connectable to one another by a plurality of connecting means, wherein each connecting means of the plurality of connecting means has at least two receiving openings, wherein each panel further comprises at least one insertion opening, wherein at least one rod-shaped fixing means is inserted or insertable into the receiving opening of the plurality of connecting means through the at least one insertion opening, and wherein each connecting means for the plurality of connecting means has at least one holding means of a first kind and at least one holding means of a second kind;
wherein the at least one holding means of the first kind is configured to hold a substantially horizontally extending reinforcing means that connects the plurality of connecting means to one another; and
wherein the at least one holding means of the second kind is configured to hold a substantially vertically extending reinforcing means that connects the plurality of connecting means to one another.

2. The arrangement according to claim 1, wherein:
the plurality of connecting means are arranged at a distance from one another, and/or
the plurality of connecting means connected by the substantially horizontally extending reinforcing means are arranged in a horizontal plane, and/or
the plurality of connecting means connected by the substantially vertically extending reinforcing means are arranged in a vertical plane.

3. The arrangement according to claim 1, wherein:
the at least one holding means of the first kind and/or the at least one holding means of the second kind is/are designed as opening, cut-out and/or recess, and/or
the at least one holding means of the first kind and/or the at least one holding means of the second kind are provided on or in the plurality of connecting means.

4. The arrangement according to claim 1, wherein:
the plurality of connecting means is configured such that the holding means of the second kind is formed by inserting the substantially horizontally extending reinforcing means into the holding means of the first kind, and/or
the plurality of connecting means is configured such that the holding means of the first kind is formed by inserting the substantially vertically extending reinforcing means into the holding means of the second kind.

5. The arrangement according to claim 1, wherein:
the at least one holding means of the first kind and/or the at least one holding means of the second kind can be folded from a first state into a second state, and
the at least one holding means of the first kind and/or the at least one holding means of the second kind is/are folded in the first state so that the at least one holding means of the first kind and/or the at least one holding means of the second kind is/are arranged within the dimensions of the plurality of connecting means, and
the at least one holding means of the first kind and/or the at least one holding means of the second kind is/are folded in the second state so that the at least one holding means of the first kind and/or the at least one holding means of the second kind projects beyond at least one side of the plurality of connecting means.

6. The arrangement according to claim 1, wherein:
the substantially horizontally extending reinforcing means is configured such that the substantially horizontally extending reinforcing means can be inserted into the holding means of the first kind when the panels are connected to one another by the plurality of connecting means, and/or
the substantially vertically extending reinforcing means is configured such that the substantially vertically extending reinforcing means can be inserted into the holding means of the second kind when the panels are connected to one another by the plurality of connecting means.

7. The arrangement according to claim 1, wherein:
the plurality of connecting means has the shape of an L at least in some sections, and/or
the at least one holding means of the first kind is arranged on a lateral surface of the plurality of connecting means, the lateral surface extending in a vertical direction, and/or
the at least one holding means of the second kind is arranged on an additional lateral surface of the plurality of connecting means, the additional lateral surface extending in a horizontal direction.

8. The arrangement according to claim 1, wherein:
the at least one holding means of the first kind and/or the at least one holding means of the second kind is/are arranged substantially symmetrically around the centre of the plurality of connecting means, and/or
the at least one holding means of the first kind and/or the at least one holding means of the second kind is/are arranged at a distance of 2 cm up to and including 35 cm from the at least one insertion opening, and/or
the at least one holding means of the first kind and/or the at least one holding means of the second kind is/are arranged at a distance of 5 cm up to and including 40 cm from the respective end region of the plurality of connecting means.

9. The arrangement according to claim 1, wherein:
the substantially horizontally extending reinforcing means and the substantially vertically extending reinforcing means each has the shape of a rod, bar or tube, and/or
the substantially horizontally extending reinforcing means and the substantially vertically extending reinforcing means each comprises metal, optical fibre and/or carbon fibre, and/or
the substantially horizontally extending reinforcing means and the substantially vertically extending reinforcing means each is made of metal, optical fibre and/or carbon fibre, and/or
the substantially horizontally extending reinforcing means and the substantially vertically extending reinforcing means each is configured to absorb tensile forces.

10. The arrangement according to claim 1, wherein:
the at least one fixing means has at least one substantially flat surface along its longitudinal direction.

11. The arrangement according to claim 10, wherein:
the at least one fixing means is arranged in one panel such that the substantially flat surface of the at least one fixing means points in the direction of another panel, and/or
the substantially flat surface of the at least one fixing means is substantially parallel to an outer surface of one panel.

12. The arrangement according to claim 1, wherein:
the at least one fixing means is arranged at least partially in the at least one insertion opening, and/or
connecting openings are provided in the panels, wherein the connecting means are at least partially arranged in the connecting openings, and/or
the connecting means are arranged substantially orthogonally to the at least one fixing means.

13. The arrangement according to claim 1, wherein:
the at least one fixing means is inserted or insertable into a plurality of receiving openings arranged in alignment with one another, through the at least one insertion opening.

14. The arrangement according to claim 13, wherein:
the receiving openings are configured to receive the at least one fixing means, and/or
the receiving openings substantially correspond to the cross-section of the at least one fixing means.

15. The arrangement according to claim 1, wherein:
the at least one insertion opening is configured to receive the at least one fixing means, and/or
the at least one insertion opening substantially corresponds to the shape of the at least one fixing means.

16. The arrangement according to claim 1, wherein:
the plurality of connecting means has at least one pivotable positioning means, and
the positioning means is configured to position the connecting means and/or the fixing means, and
the positioning means can be brought from an insertion position in which the positioning means exposes substantially the entire receiving opening into a positioning position in which the positioning means positions the connecting means and/or the fixing means.

17. The arrangement according to claim 1, wherein:
the plurality of connecting means has at least one spacer,
the at least one spacer being arranged on the circumference of the receiving opening, or on the circumference of the plurality of connecting means, or on the circumference of the at least one holding means of the first kind and/or the at least one holding means of the second kind, or on the circumferences of the substantially horizontally extending reinforcing means and/or the substantially vertically extending reinforcing means.

18. The arrangement according to claim 1, wherein:
the panels are made of extruded polystyrene or expanded polystyrene.

19. The arrangement according to claim 1, wherein:
the panels have a height in the range of 250 cm up to and including 400 cm, and/or
the panels have a width in the range of 50 cm up to and including 200 cm, and/or
the panels have a depth in the range of 5 cm up to and including 80 cm.

20. The arrangement according to claim 1, wherein:
the panels are arranged at a distance from one another, and
the distance between the panels is in the range of 5 cm up to and including 50 cm.

21. The arrangement according to claim 1, wherein:
at least one expansion joint is provided on at least one outer surface of at least one panel, and/or
the at least one expansion joint extends over the entire width of the panel and/or has a length in the range of 50 cm up to and including 200 cm, and/or
the at least one expansion joint has a height in the range of 0.1 mm up to and including 5 mm, and/or
the at least one expansion joint has a depth in the range of 1 mm up to and including 20 mm, and/or
two expansion joints are provided on a panel with a distance between these two expansion joints in the range of 10 cm up to and including 120 cm.

22. The arrangement according to claim 1, wherein:
the receiving openings are arranged opposite each other on the plurality of connecting means, and/or
the distance between the receiving openings is in particular in the range of 15 cm up to and including 70 cm.

23. The arrangement according to claim 1, wherein:
the plurality of connecting means has two insertion sections, and/or
the insertion sections are configured for the insertion into connecting openings of the panels, and/or
the insertion sections are bevelled, rounded and/or pointed.

24. The arrangement according to claim 1, wherein:
the fixing means has at least one insertion region, and/or
the at least one insertion region is configured for the insertion into the insertion opening of the panels, and/or for the insertion into the receiving opening of the plurality of connecting means, and/or
the at least one insertion region is bevelled, rounded and/or pointed.

25. The arrangement according to claim 1, wherein:
the plurality of connecting means have a length in the range of 25 cm up to and including 80 cm, and/or
the plurality of connecting means have a width in the range of 5 mm up to and including 100 mm, and/or
the plurality of connecting means have a depth in the range of 5 mm up to and including 100 mm.

26. The arrangement according to claim 1, wherein:
the fixing means has a length in the range of 50 cm up to and including 200 cm, and/or
the fixing means has a width in the range of 5 mm up to and including 50 mm, and/or
the fixing means has a depth in the range of 5 mm up to and including 50 mm.

27. (canceled)

28. (canceled)

29. (canceled)
